(19) United States
(12) Patent Application Publication
(10) Pub. No.: US 2011/0154013 A1
(43) Pub. Date: Jun. 23, 2011

(54) ELECTRONIC WASTE AND CARBON FOOTPRINT REDUCTION SYSTEM

(75) Inventor: Harold L. Peterson, Scotts Valley, CA (US)

(73) Assignee: DIGITAL DELIVERY NETWORKS, INC., Scotts Valley, CA (US)

(21) Appl. No.: 12/836,806

(22) Filed: Jul. 15, 2010

Related U.S. Application Data
(63) Continuation-in-part of application No. 12/505,704, filed on Jul. 20, 2009.
Application No. 12/505,704 is a continuation-in-part of application No. 11/879,213, filed on Jul. 16, 2007.

(51) Int. Cl. G06F 1/24; G06F 9/00

(52) U.S. Cl. 713/100; 713/1

(57) ABSTRACT

An electronic device, a method for manufacturing the electronic device, and a method for using the electronic device. A component unit is provided that has a total performance capacity including an enabled and an additional performance capacities, wherein the additional performance capacity is prevented from being employed by the electronic device until enabled with an access logic run in the electronic device with a key associated with the additional performance capacity.

### CROSS-REFERENCE TO RELATED APPLICATIONS

This is a continuation-in-part of application Ser. No. 12/505,704, Jul. 20, 2009, currently pending, which is a continuation-in-part of application Ser. No. 11/879,213, filed Jul. 16, 2007, currently pending, both hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which may be subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

1. Technical Field

The present invention relates generally to electronic devices, and more particularly to selectively accessing performance capacities in such devices so they are used for longer periods of time and replaced less frequently.

2. Background Art

Electronic devices have become ubiquitous in our modern society. Consider just the following few examples drawn from among consumer electronics used for computing, entertainment, and communications. We have personal computers (PCs), which today include desktop units (traditional PCs) and portable varieties such as laptops, notebooks, and netbooks. We have digital still and video cameras as well as audio recording devices, and for playback we have MP3 and other format music players, e-book players, and portable digital versatile disc (DVD) players. And we have cellular telephones, radios, televisions, digital video recorders (DVRs), wired and wireless network hardware, multi-player gaming counsels, and digital frames that play images, movies, audio clips, etc.

An aspect common to essentially all electronic devices is that they have hardware-based performance capacities, which are usually dictated by the quantity and quality of the circuits in the devices. For instance, some performance capacities are based on the quantity and quality of logic processing circuits, with common examples being the number (quantity) of processors present (or the number of cores in each processor), the type (quality) of processor or processors, and the speed (another quality attribute) of the processor or processors. Other performance capacities can be based on the quantities, types, and speeds, of data memory and data storage. [The term “memory” is used herein in a dynamic sense and the term “storage” is used in a static sense.] Yet other examples of performance capacities abound, albeit ones usually less general. For instance, the number of sound channels, such as mono, stereo, and 5.1 versus 7.1 channel surround sound. Or five or ten megapixel image sensors in cameras, camcorders, and cell phones; or the speeds and sensitivity levels (quality attributes) of these sensors.

Historically the two primary ways to change performance capacities have been replacing existing component units and adding additional component units. Additionally, two increasingly common ways to “change” performance capacities are down-representing and down-configuring electronic devices.

The common PC serves as an example where all of these approaches may be employed. In a PC a finite number of microprocessor sockets, memory slots, and storage bays (spaces for storage units) are present. In most PCs, the memory slots are fully populated at purchase. For instance, if a board has four slots for memory, each may contain a 256 megabyte (MB) component when the PC is purchased. If a user then wants to upgrade the PC to have a four MB memory, they have to replace the existing low performance capacity component units with higher capacity ones. In contrast, in many PCs at least one storage bay is empty at purchase. Thus a PC may come with a 250 gigabyte (GB) disk drive and a user may later upgrade the PC by adding an additional 750 GB disk drive. Of course, if the PC does not have any remaining empty sockets, slots, or bays, replacement is again the only likely option.

The common PC also serves as a further example here, being one of the most upgradable electronic devices ever produced. When the memory modules or the processor in a PC are upgraded, the old component units typically become trash but this is at least less wasteful than replacing the entire electronic device.

Both down-representing and down-configuring have long histories when applied to component units. For example, a memory chip manufacturer may produce units that are all capable of 25 nanosecond access speeds, but label and sell half of their production as having a 40 nanosecond rating. Similarly, a microprocessor manufacturer may configure part of a production run so that only half of the actual on-chip cache memory is enabled. In both of these cases the manufactures sell two grades of components, usually at quite different prices. Of interest here, however, are down-representing and down-configuring in the context of finished electronic devices.

Down-representing an electronic device does not entail actually changing a performance capacity, instead the device is sold with one or more performance capacities that exceed what it is represented or advertised as having. Various reasons may lead a manufacture to do this. For example, devices and the marketing campaigns for them may be designed based on currently available components, only to have the devices actually manufactured using later available components that have greater performance capacities. Alternately, manufacturing electronic devices with greater performance capacity may be relatively inexpensive or even cheaper due to an economy of scale or other market factor. For instance, a 750 GB storage component typically costs only 1.2 times as much as a 500 GB storage component (20% more, rather than 50% more), but the cost may effectively be reduced more by purchasing, say, 10,000 units of one component rather than purchasing, stocking, and manufacturing with 5,000 units each of two different components.

Down-representing actual performance capacities is not without potential problems. The manufacturer (or the vendor if the device is a “house branded” one commissioned by a major vendor) faces hard choices related to giving purchasers more than what they are paying for. For instance, entry level devices typically are priced at or near cost, to entice new consumers to a brand or in the hopeful expectation of profiting eventually from tied-in sales. Manufacturers and vendors therefore do not want it widely known that consumers can simply buy a lower priced device and get all of the performance of a higher priced device. Down-representing can also lead to consumers searching for devices with the latest manufacturing date or the newest looking box, (analogous to a “milk carton test” where a consumer checks every carton on a store shelf for the one with the latest expiration date).

Down-configuring is much as its label implies, being when a manufacture intentionally configures one or more performance capacities below what the device is capable of. For example, a PC manufacturer may want to use only one grade of microprocessor in products having three different processor speeds and prices. A very simple way that the PC manufacturer might do this is to configure the speeds differently in the PC motherboard (e.g., in the BIOS settings), and a more sophisticated approach might be to run microcode that internally changes the microprocessor settings (if the component manufacturer will provide their proprietary microcode for this).

Down-configuring actual performance capacities is also not without potential problems. If this becomes widely known or even wrongly suspected, potential purchasers may skew the market by purchasing such devices and then trying to reconfigure them themselves. There are also many potential follow-on issues related to this, such as failed changes, desired but impossible changes, peripheral damage to the device, downstream effects like shortened device life, etc. Such issues frequently create technical support problems which manufactures and vendors then have to deal with. Some notorious examples here relate to microprocessor “overclocking,” wherein end users reconfigure electronic devices to run microprocessors at higher than manufacturer rated clock speeds.

As can be seen from the Cross-Reference To Related Applications section herein, this patent application is the third for a series of inventions. Generalizing, the first application disclosed enabling access to additional performance capacity in memory and the second added enabling access to additional performance capacity in storage. In this application performance capacity is treated more expansively and generically, but conceptually as a technological extension of the principles disclosed in the parent applications. More importantly, the inventor has come to realize that these inventions solve an important set of additional problems, beyond just the technical and commercial ones covered in the previous applications. This discussion now turns to a background introduction of these additional problems.

An unfortunate aspect that is also common to essentially all electronic devices today is that they eventually end up in the trash. Everything fails at some point but, more commonly, many still working electronic devices are simply discarded, typically when they are replaced with devices that have greater or different performance capacities. Granted, some electronic devices are upgraded, thus extending their lives cycles, but the net result is usually that the replaced parts just end up in the trash earlier than the rest of the device. Recall also that many electronic devices are not upgradable, and note as well that many upgradable devices never are upgraded. This produces waste and electronic trash, and increases our carbon footprint when replacements are manufactured and marketed.

Cellular telephones and televisions illustrate the rough extremes in the range of consumer electronic device life-usage cycles. Cell phones are now routinely replaced annually and televisions are now rarely used beyond five years. Nonetheless, these devices are usually still in excellent working order when the original owner gives them away, throws them away, sells them, or stores them until they eventually do one of these. Furthermore, while giving and selling are listed here, they minimally add to overall device life-usage cycles. Used cell phones can be found in resale markets for $5 each or three for $10, but with few takers, and used televisions usually see only short or limited use (e.g., when put in a guest room or garage).

Some of our electronic trash is recycled, but much is not. Small devices (e.g., cell phones) and waste component units from upgrades tend to literally go “into the trash” and thus into local landfills.

As for the electronic trash that we do recycle, the nature of the recycling varies widely, with only some being clean, safe, and ethical. An appreciable portion of electronic recycling today entails simply sending our discards to less affluent places, were a small portion of the electronic devices are actually salvaged and the rest goes into growing trash heaps. The social costs in these less affluent places is often appalling, using child labor, with little or no concern for industrial safety, and exposing workers and the surrounding countryside to chemical pollutants. Ironically, many people in more affluent places only become aware of all of this when some of these chemical pollutants make their way downstream, into new manufacturing processes, and come back to us as lead content in toys and carcinogens in clothing.

There are many ongoing efforts to improve electronic device recycling, but these so far are largely based on punishments rather than true incentives. Legislative efforts to reduce our use of mercury and lead are notable examples here. Other legislative efforts have included recycle taxes on electronic devices and mandates that vendors accept back obsolete devices.

These efforts have, however, produced mixed results. Our reduction in the use of mercury is probably due more to coincidental changes in the electronics industry than legislation (e.g., using fewer high current vacuum tubes and level switches). Compulsory changeover to lead free solders (e.g., due to the Directive on the Restriction of the Use of Certain Hazardous Substances in Electrical and Electronic Equipment (RoHS) adopted in February 2003 by the European Union) has complicated manufacturing and actually been somewhat counter-productive, with the higher temperatures which these solders require making devices harder to repair, increasing production failure rates, and decreasing component (and thus device) life expectancies. Recycle taxes have been weakly and sporadically implemented, with some vendors collecting them and others not, with consumers purchasing more cheaply via the internet from jurisdictions where these do not apply, and with these taxes frequently funding expensive but ineffective educational campaigns or simply underwriting the shipping of electronic trash to less affluent places. Vendor acceptance back of obsolete devices has also proven unpopular and unworkable, and when these programs work at all they often just help funnel our electronic trash yet onward to less affluent places.

Observing this situation, the present inventor has noted that this series of inventions provides technical and commercial rewards to consumers, vendors, and manufactures, and this has prompted a number of considerations. What if rewards (as true incentives rather than penalties like taxes) could also reduce electronic waste and trash? What if consumers had true incentives to keep cell phones for more than one year, PCs for more than two years, and televisions for more than five years? What if technical and commercial rewards to consumers, vendors, and manufactures could be leveraged to concurrently entice consumers to use their electronic devices longer? Thoughts like these have brought the present inventor to realize that the series of inventions here inherently furthers these goals to some extent and, for some embodiments, can be optimized for this, thus reducing electronic waste and trash and our carbon footprint.

### BRIEF SUMMARY OF THE INVENTION

Accordingly, it is an object of the present invention to provide a system to reduce electronic waste and trash and our carbon footprint.

Briefly, one preferred embodiment of the present invention is an electronic device. The electronic device has a component unit which has a total performance capacity including an enabled performance capacity as well as an additional performance capacity. The additional performance capacity is prevented from being employed by the electronic device until enabled with an access logic run in the electronic device with a key associated with the additional performance capacity.

Briefly, another preferred embodiment of the present invention is a method for manufacturing an electronic device. The electronic device is built including a component unit that has an alterable performance capacity. The component unit is then configured to have an enabled performance capacity and an additional performance capacity, wherein the additional performance capacity is prevented from being employed by the electronic device until enabled by an access logic running in the electronic device with a key associated with the additional performance capacity.

And briefly, another preferred embodiment of the present invention is a method for a user of an electronic device to alter its performance capacity. The electronic device has a component unit that has an alterable performance capacity. This alterable performance capacity includes an enabled performance capacity and an additional performance capacity. The additional performance capacity is prevented from being employed by the electronic device until enabled by an access logic run in the electronic device with a key associated with the additional performance capacity. The method here then includes running the access logic in the electronic device, informing the user that an upgrade permitting access to the additional performance capacity is available, and determining if the user wishes the upgrade. If so, the user is permitted to purchase the upgrade, the key associated with the additional performance capacity is transferred to the electronic device from an external source, and the key associated with the additional performance capacity is applied with the access logic to enable the additional performance capacity.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended tables and figures of drawings in which:

TBL. 1a shows the theoretical performance capacities of the controller in FIG. 1 and TBL. 1b shows those that would most likely actually be used.

TBL. 2 shows the performance capacities of the memory in FIG. 1 that would most likely actually be used.

And TBL. 3 shows the performance capacities of the storage in FIG. 1 that would most likely actually be used.

FIG. 1 is a block diagram of an exemplary electronic device that may be used in the inventive system and have performance capacity in one or more performance-alterable component units controllably enabled.

FIGS. 2a-d depict how an access logic can be run in alternate manners and at alternate times, wherein FIG. 2a shows the access logic run when starting up the electronic device, FIG. 2b shows the case in FIG. 2a taken to a logical end by running the access logic continually, FIG. 2c shows the access logic run by a logic unit at start up, and FIG. 2d shows the case in FIG. 2c taken to a logical end by running the access logic continually.

FIG. 3 is a block diagram of some exemplary activation mechanisms that may be used in the inventive system to enable access to additional performance capacities in the electronic device in FIG. 1.

FIG. 4 is a flow chart of a manufacturing process that may be used in the inventive system for manufacturing the electronic device in FIG. 1.

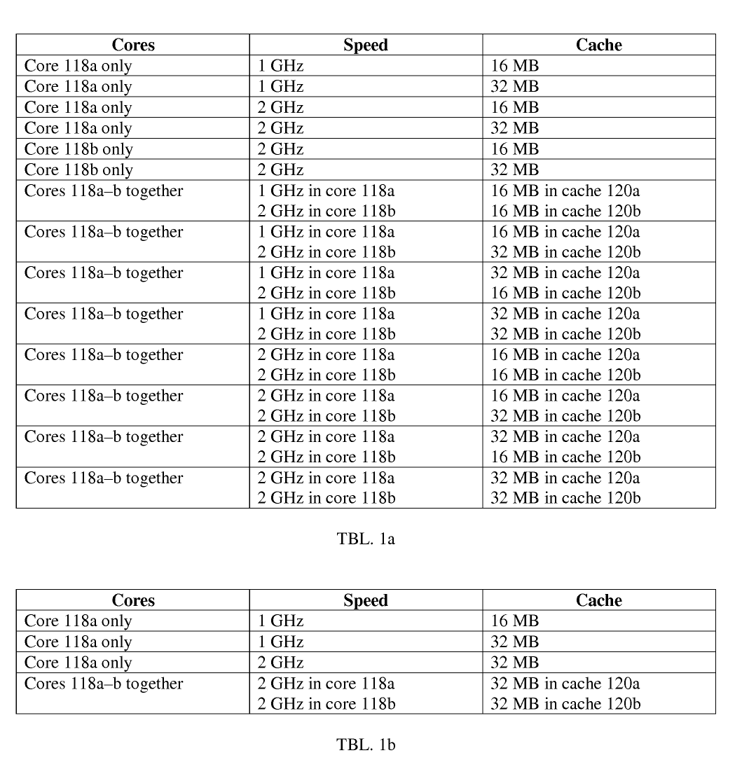

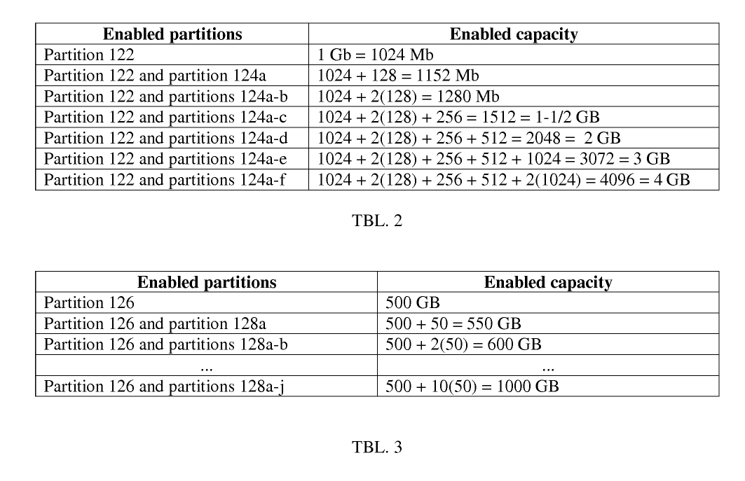

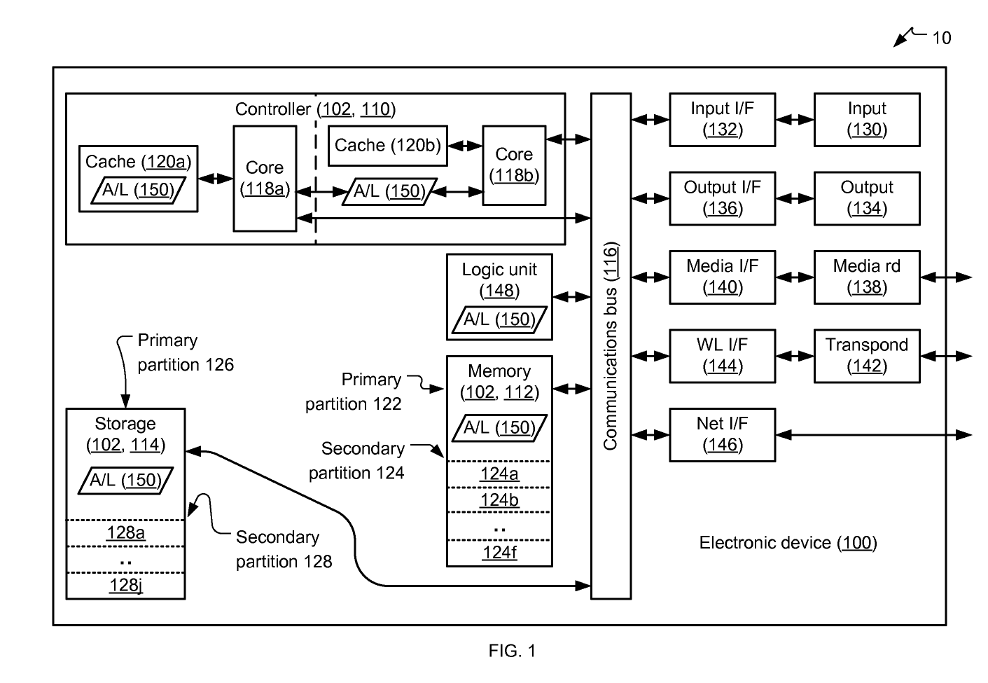

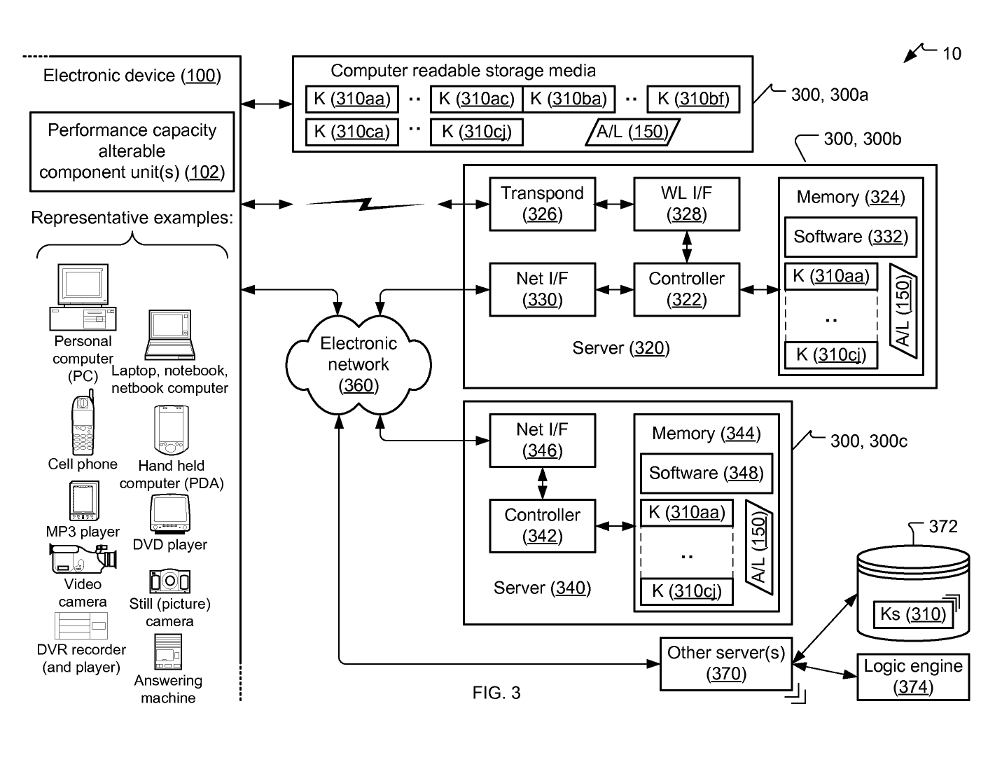

And FIG. 5 is a flow chart of an upgrade process that may be used in the inventive system to enable access to an additional performance capacity in the electronic device in FIG. 1 by using one of the activation mechanisms in FIG. 3.

In the various figures of the drawings, like references are used to denote like or similar elements or steps.

### DETAILED DESCRIPTION OF THE INVENTION

The present invention is a system for enabling access to additional performance capacities in electronic devices, and thus reducing electronic waste and trash and our carbon footprint. As illustrated in the various drawings herein, embodiments of the invention are depicted by the general reference character 10.

FIG. 1 is a block diagram of an exemplary electronic device 100 that may be used in the inventive system 10 and have the performance capacity of one or more performance-alterable component units 102 controllably enabled. The electronic device 100 here includes a controller 110, a memory 112, a storage 114, and a communications bus 116 connecting all of these. Each of these components has a performance capacity, and here the controller 110, memory 112, and storage 114 particularly have performance capacities that can individually be changed, making them examples of performance-alterable component units 102.

Note, the performance capacity of a communications bus can also theoretically be changed separately from the components it connects, but it is more common for the performance capacity of a communications bus to be either fixed or to change in concert with the performance capacities of the components that it connects. The examples used herein are based on the common case but, once the teachings herein are grasped, it should be appreciated that the spirit of the present invention can be extended to embrace many uncommon cases as well.

The controller 110 here includes two central processing unit (CPU) cores 118a-b, with each having a respective cache 120a-b. In other electronic devices the controller might instead include only a single CPU or more than two. For instance, single CPU cores are common in devices like cellular telephones and four and even eight CPU cores are becoming common in devices like PCs. Each CPU core can also include multiple caches, e.g., one per CPU or as different levels of cache (e.g., four MB of highest speed “L1” cache and 16 MB of lower speed “L2” cache). Alternately, the controller need not include any cache, but most modern microprocessor-based CPUs today do and the ones in FIG. 1 facilitate discussion here of aspects of some sophisticated embodiments of the electronic device 100.

The performance capacity of the controller 110 can be changed in a number of manners. One is to alter the number of cores 118a used, that is, by enabling only core 118a, only core 118b, or both. Another manner is to change the clock speed of the core or cores that are enabled. And another manner is to change the amount or amounts of the cache 120a-b in the cores that are enabled. As a hypothetical example, say that core 118a can be run at clock speeds of either one or two gigahertz (GHz) and that core 118b can be run at just a clock speed of two GHz. Say further that both cache 120a-b can be set to either 16 or 32 megabytes (MB). TBL. 1a shows the theoretical performance capacities this produces, and TBL. 1b shows those that would most likely actually be used.

Before continuing note that still another manner to change the performance capacity of the controller 110 is to have the cores 118a-b be of different types, say, able to run different instruction sets or with only some instruction sets enabled. As a historical example, some early PC motherboards held an Intel™ 8086 main CPU and had a socket to accept an 8087 math coprocessor. A consumer then could buy the PC without the math coprocessor and upgrade if and when they desired.

Continuing with FIG. 1, the memory 112 here includes a primary partition 122 and a partition block 124 that includes one or more secondary partitions (secondary partitions 124a-f in this example). Here the primary partition 122 has a one GB capacity, secondary partitions 124a-b each have 128 MB capacities, secondary partition 124c has a 256 MB capacity, secondary partition 124d has a 512 MB capacity, and secondary partitions 124e-f each have one gigabyte (GB) capacities. The result is a potentially usable four GB total memory performance capacity that is incrementally configurable. TBL. 2 shows the performance capacities here that would likely actually be used.

Continuing further with FIG. 1, the storage 114 here includes a primary partition 126 and a partition block 128 that includes one or more secondary partitions (secondary partitions 128a-j in this example). Here the primary partition 126 has a 500 GB capacity and the additional secondary partitions 128a-j each have 50 GB capacities. The result is a potentially usable 1000 GB (one terabyte) total storage performance capacity that is incrementally configurable. TBL. 3 shows the performance capacities here that would likely actually be used.

The communications bus 116 connects the controller 110, the memory 112, and the storage 114, and here in FIG. 1 it also connects a number of peripheral elements in the electronic device 100. These include an input device 130 and an input interface 132; an output device 134 and an output interface 136; a media reader 138 and a media interface 140; a wireless transponder 142 and a wireless interface 144; a network interface 146; and a logic unit 148.

The electronic device 100 shown in FIG. 1 additionally includes multiple examples of one other important element: an access logic 150 comprising instructions that are executable by at least one of the CPU cores 118a-b or by the logic unit 148. At the point when a user receives the electronic device 100, one or more instances of the access logic 150 may already be present in the controller 110, e.g., in read only memory (ROM) or flash memory, or may be present in the logic unit 148, e.g., in similar memory there, or an access logic 150 may be stored in the storage 114. Alternately, the access logic 150 can be received into the electronic device 100 later via the media reader 138 off of a computer readable storage media, or it can be received via the wireless transponder 142 or the network interface 146. Optionally, if it has newly been received in one of these manners, the access logic 150 can then be stored in the storage 114.

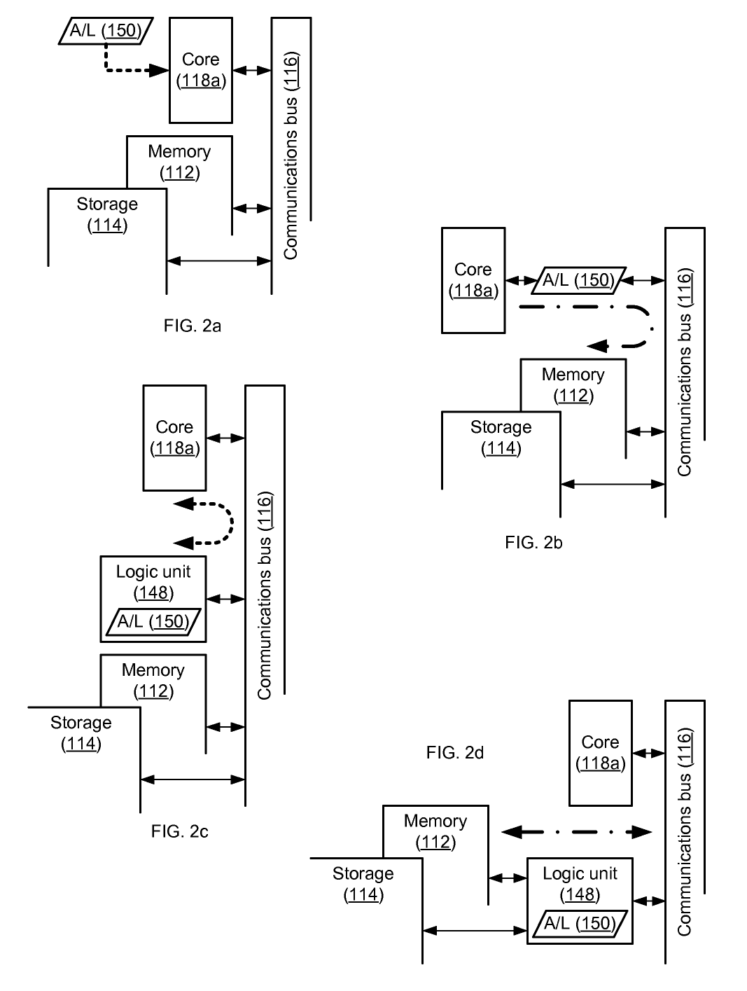

FIGS. 2a-d are schematic block diagrams depicting how some exemplary embodiments of the access logic 150 can be run in alternate manners and at different times. In the approach shown in FIG. 2a the access logic 150 is run by the first CPU core 118a when starting up the electronic device 100. Here the access logic 150 “tells” the core 118a what the enabled performance capacities of the electronic device 100 are. For instance, here the electronic device has respective performance capacities in each of the controller 110, memory 112, and storage 114, so the access logic running in the core 118a sets each of these performance capacities and the electronic device 100 thereafter should proceed as if only these performance capacities are present. Note, potentially the desired performance capacity of the controller 110 might entail running only core 118b, then the access logic 150 would enable core 118b and disable core 118a, with core 118b then taking over. Based on the typical configurations expected for the controller 110 (see e.g., TBL. 1b) this would not be necessary, but the access logic 150 can handle it if were necessary.

The approach in FIG. 2a is suitable for many electronic devices 100, but for some that do not perform elaborate start-up configuration it may be unsuitable and for others it may be unduly vulnerable to hacking. The rest of the examples here are based on only core 118a being enabled.

The approach shown in FIG. 2b takes the case in FIG. 2a to a logical end. The access logic 150 is run continually by the core 118a, with the access logic 150 logically interposed so that core 118a only “sees” the enabled capacities. This approach therefore is not limited to working only at start-up (or periodically based on some other triggering event) and accordingly is less vulnerable to hacking, but at the expense of some added burden on core 118a as it runs the access logic 150.

In the approach shown in FIG. 2c the access logic 150 is run by the logic unit 148 at start up of the electronic device 100. The access logic 150 here can “tell” the core 118a what the enabled capacities are or it can logically interpose itself temporarily so that the core 118a only “sees” the enabled capacities during start-up and session configuration routines. This approach is also somewhat harder to hack. Additionally, this can provide design and manufacturing advantages. For instance, while the logic unit 148 is depicted in the figures as a single discrete unit, one or more instances of it can instead be integrated into modules or units of the memory 112 and/or the storage 114. A manufacturer of the electronic device 100 then, for example, can simply buy hard disk drives that already have integral logic units 148 and thus not have to be concerned with most details of the logic unit 148 or the access logic 150.

The approach shown in FIG. 2d takes the case in FIG. 2c to a logical end. The access logic 150 is run continually by the logic unit 148, effectively acting as if the logic unit 148 is physically interposed between the core 118a and the memory 112 and/or the storage 114. Here the core 118a is only effectively able to “see” what the access logic 150 allows it to see. The logic unit 148 used here can be designed to strongly thwart hacking and, as in the case in FIG. 2c, it and the access logic 150 can optionally be integrated into modules or units of the memory 112 and/or the storage 114.

A seeming problem in the approaches shown in FIGS. 2c-d is ongoing control of the performance capacities of the controller 110. Clearly, having every operation in the controller 110 require checking with the logic unit 148 for permission to proceed is impractical, since this will heavily burden the communications bus 116 and slow all operations down. This problem, however, is actually easily solved. Rather than “put” every operation of the controller 110 on the communications bus 116 for the logic unit 148 to monitor, the logic unit 148 can periodically query the controller 110 for its current configuration and/or monitor normal traffic on the communications bus 116 and infer much about the current configuration of the controller 110 from this.

For example, in the arrangement shown in FIG. 2c the logic unit 148 can put instructions on the communications bus 116 that the controller 110 runs, and from which the logic unit 148 can then determine what the current performance capacities of the controller 110 are and whether these are “authorized.” A hacker's program running in the controller 110 theoretically could defeat this approach, but only by continually monitoring all operations in the controller 110 and thus seriously burdening it.

As an alternate example, in the arrangement shown in FIG. 2d the logic unit 148 is strongly (physically or effectively) interposed between the memory 112 and/or storage 114 and the communications bus 116. If the logic unit 148, in due course or after an action it takes, observes or fails to observe any activity involving the authorized performance capacities of the electronic device 100, the logic unit 148 can simply lock out the memory 112 and/or the storage 114, disable the communications bus 116, etc.

FIG. 3 is a block diagram of some exemplary activation mechanisms 300 that may be used in the inventive system 10 to enable access to additional performance capacities in the electronic device 100 in FIG. 1. Briefly, the activation mechanisms 300 work with an instance of the access logic 150 in the electronic device 100, optionally providing or updating the access logic 150 if it is not already present or if it is obsolete, to procure keys 310 that the access logic 150 uses to “unlock” and thus enable additional performance in the component units 102. The activation mechanisms 300 shown in FIG. 3 include a media-based mechanism 300a, a wireless-based mechanism 300b, and a physical network-based mechanism 300c.

Turning first to the media-based mechanism 300a, this may be embodied in an electronically readable (e.g., computer readable) storage media that the media reader 138 of the electronic device 100 can read. Accordingly, this media can be a floppy disc, tape, CD, DVD, USB flash memory, external hard drive, etc. This list is not exhaustive and it should be appreciated that the nature of the media is generally not a limitation. The media-based mechanism 300a includes one or more keys 310 (e.g., key 310aa) and it optionally may also include a copy of the access logic 150. If a copy of the access logic 150 is present and the nature of the media permits this, the access logic 150 may further optionally automatically execute when the media-based mechanism 300a is loaded into and read by the electronic device 100.

In FIG. 3 the keys 310 present in the media-based mechanism 300a include keys 310aa-ac, which are associated with the cores 118a-b and cache 120a-b of the controller 110 of the electronic device 100, keys 310ba-bf, which are associated with the secondary partitions 124a-f in the memory 112 of the electronic device 100, and keys 310ca-cj, which are associated with the secondary partitions 128a-j in the storage 114 of the electronic device 100. The keys 310aa-ac unlock respective higher performance capacities in the cores 118a-b and cache 120a-b of the controller 110. Note, the top entry in TBL. 1b is for a default, minimum performance capacity and does not necessarily require a key 310 (of course, one could be used if desired). Similarly, keys 310ba-bf unlock respective higher performance capacities in the memory 112 (see e.g., TBL. 2). And keys 310ca-cj unlock respective higher performance capacities in the storage 114 (see e.g., TBL. 3). In this manner specific keys 310 may be used to unlock all of the performance capacities in the electronic device 100, taking it from a low performance device with a single core running at one GHz with a 16 MB cache, 1 GB of memory, and 500 GB of storage all the way to a high performance device with a dual-core set running at two GHz both with 32 MB of cache, 4 GB of memory, and 1000 GB of storage.

Note, the media-based mechanism 300a here is shown having copies of all of the keys 310 for all of the possible performance enable-able performance capacities in the electronic device 100. This is not a requirement. A particular instance of the media-based mechanism 300a might instead have as little as a single key 310 for only enabling one performance capacity change, or a particular instance of the media-based mechanism 300a might have a large number of keys that work with multiple different electronic devices.

Turning now to the wireless-based mechanism 300b, this is embodied in a server system 320 that includes a controller 322, a memory 324, a wireless transponder 326 and a wireless interface 328, and an optional network interface 330. The memory 324 here further includes a software module 332, an optional copy of the access logic 150, and keys 310aa-ac, 310ba-bf, 310ca-cj. Typically, the server system 320 would have a storage from which the memory 324 is loaded, or even that is used instead off a memory, but the net result in the approach here would remain the same. Note also, the server system 320 here as well may have copies of only some or all of the keys for a given electronic device, or have copies of only some or all for multiple different electronic devices.

Turning next to the physical network-based mechanism 300c, this is also embodied in a server system 340. Potentially the server system 340 can be the same as the server system 320, but this is not a requirement and to emphasize this the server system 340 here is depicted with different components. Continuing, the server system 340 includes a controller 342, a memory 344, and a network interface 346. The memory 344 here further includes a software module 348, an optional copy of the access logic 150, and keys 310. The software module 348 may be, but need not necessarily be, the same as the software module 332, and the remarks above about the keys and using memory and/or storage apply here as well.

FIG. 3 further includes two additional objects that merit discussion. An electronic network 360 is shown for use with the server system 340, and optionally also with the server system 320. Furthermore, a set of other servers 370 is shown to generically represent other systems that may be used in the greater context of applying this invention. For instance, one of the other servers 370 might be that of a financial institution that receives payment from a user of the electronic device 100 and informs the server system 320 or the server system 340 of this, typically so that the server system 320, 340 will communicate a copy of one or more keys 310 to the electronic device 100. Alternately, and potentially additionally, one of the other servers 370 may be a system that has a media writer with which tailored instances of the media-based mechanism 300a are created, say, to be mailed or sent by courier to a user of the electronic device 100. Still alternately, one of the other servers 370 may be a system that provides the keys 310 to the server systems 320, 340, say from a databases 372 that centrally stores the keys 310 or from a logic engine 374 that generates the keys 310.

Before wrapping up discussion of the electronic device 100 and the activation mechanisms 300 here, some additional coverage of general aspects of enabling performance capacities is appropriate. Such an enabling can be a permanent change or, in sophisticated embodiments of the present invention, it can also be temporary.

Thus, continuing with the ongoing examples in FIGS. 1-3, permanently unlocking the second core 118b or enabling all of the capacity of the cache 120a are straightforward once the above principles are grasped. Enabling portions of the partition blocks 124, 128 are also generally straightforward in view of the above principles. A potential problem that may arise is whether what is being enabled is contiguous with its respective primary partition 122, 126 and/or other portions of the partition blocks 124, 128 that are now or have already been enabled. But there are many simple solutions to this problem that are already known in the art, where they have long been used to handle other memory and storage issues, and these are not repeated here.

Temporarily unlocking a performance capacity should also now be straightforward based on the above technical discussion, but here many additional sophisticated advantages also become possible. In embodiments of the present invention providing this feature, the access logic 150 can monitor for and respond to a trigger to re-lock or de-enable a performance capacity. Some examples of triggers for this are the passage of a period of time, an event internal to the electronic device 100, and/or an event external to the electronic device 100. The passage of a period of time can, of course, be regarded as an event internal to the electronic device 100, but it is listed separately and first here to emphasize how it particularly can be used in combination with other triggers. Most electronic devices 100 today have an internal clock (and many also are able to synchronize with an external one). Accordingly, the passage of a period of time can easily be used as a Boolean trigger. That is, permitting something to happen or to not happen for a set period of time. For instance, a user of the electronic device 100 may simply purchase the right to enable all of the higher performance capacities for one year. These are then unlocked, a clock is monitored, and after one-year the access logic 150 re-locks or de-enables the higher performance capacities. Alternately, a user of the electronic device 100 may subscribe to an online service wherein the higher performance capacities are unlocked for three months as a sign-up incentive and wherein they will remain usable as long as the user maintains the subscription. Here the access logic 150 unlocks/enables and sets a three month “do not turn off” trigger. Even if the user then cancels their subscription the day after obtaining it and the access logic 150 detects that the subscription is no longer active, the access logic 150 here will wait until at least the three month period has expired before re-locking or de-enabling anything. Still alternately, a manufacturer may not want their vendors steering potential purchasers to low-capacity enabled devices over high-capacity enabled ones. Here a six month “do not turn on” trigger can be set (say one that further is initiated by initial user activation of the device), and the access logic 150 here will not enable anything (even with an otherwise proper key) until at least six months has passed.

Before wrapping up discussion of the electronic device 100 and the activation mechanisms 300 here, some additional remarks about the keys 310 are also appropriate. A very wide variety of types of keys 310 may be used. In simple embodiments of the present invention the keys 310 may be simple passwords. For example, although not shown in the figures and not expected to be used frequently, a simple key 310 such as a password could be recited to or left as a voice mail message for an end user of an electronic device 100. The end used then could manually enter the key 310 into the electronic device 100 in response to a dialog provided by the access logic 150. Note, this approach, or one where a key 310 is e-mailed to a user and then cut and pasted into an access logic dialog, may especially be useful in technical support scenarios.

In most embodiments, however, it is expected that the keys 310 will be more sophisticated. For instance they may be complex bit or character strings. They may be values generated with a formula, random values, hash values, symmetric or asymmetric encryption keys, etc. They may or may not be unique. What is used as a key 310, and how robust and secure the manner of its generation and use are, are matters of design choice and the present invention accordingly can be embodied to accommodate a very wide range of application scenarios.

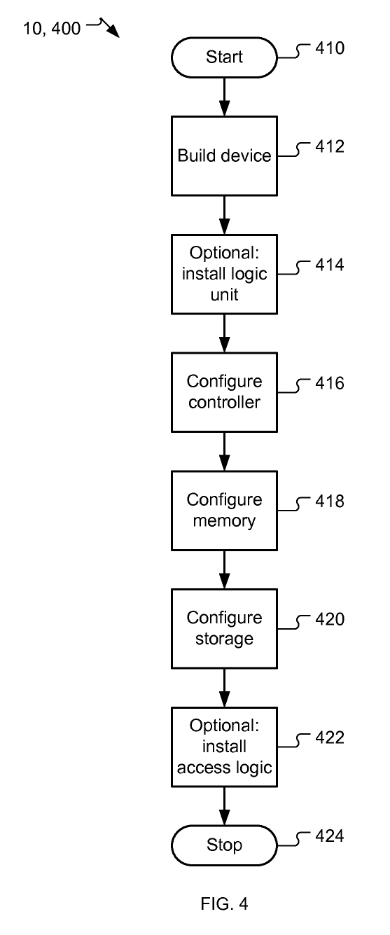

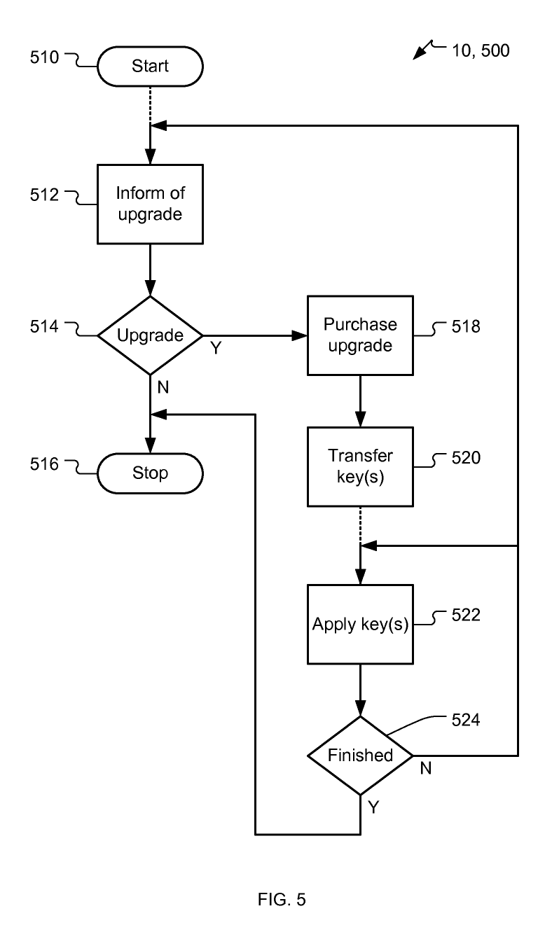

FIG. 4 is a flow chart of a manufacturing process 400 that may be used in the inventive system 10 for manufacturing the electronic device 100 in FIG. 1. Recall that this exemplary electronic device 100 has performance capacities in the controller 110, memory 112, and storage 114 that are all upgradable.

The manufacturing process 400 begins in step 410. Initialization and set-up typically occur here. For example, design of the electronic device 100 occurs here and components with specific capacities are chosen (e.g., components for the controller 110, memory 112, and storage 114).

In a step 412 the electronic device 100 is built, generally. The components actually used here for the controller 110, memory 112, and storage 114 may be those chosen in initial design or they may be others with equal or greater capacities.

In an optional step 414 an instance of the logic unit 148 is included in the electronic device 100. This is optional because the logic unit 148 is provided and used in some embodiments of the electronic device 100 and not required or used in others.

In a step 416 the controller 110 in the electronic device 100 is configured with the initial controller performance capacity that the electronic device 100 will have and be able to employ. A key point here, however, is that the controller 110 is configured to have a performance capacity different than what it is actually capable of.

In a step 418 the memory 112 in the electronic device 100 is configured with the initial memory performance capacity that the electronic device 100 will have and be able to employ. A key point here, however, is that the memory 112 is also configured to have a performance capacity different than what it is actually capable of.

In a step 420 the storage 114 in the electronic device 100 is configured with the initial storage performance capacity that the electronic device 100 will have and be able to employ. A key point here, however, is that the storage 114 is also configured to have a performance capacity different than what it is actually capable of. [Note, the present example has changeable performance capacities in all of the controller 110, memory 112, and storage 114. Alternate embodiments of the manufacturing process 400 can have as few as one such performance capacity in just one of these (or yet another) component units.]

Digressing briefly, the similarity between steps 416-420 should be noted. The technical aspects of unlocking/enabling or locking/de-enabling (“configuring” here) may vary, but the performance capacities can all conceptually be viewed similarly. Thus, for instance, if the electronic device instead were a cellular telephone with an image sensor, configuring this for, say, initial one mega pixel use that is upgradeable to four mega pixel use is conceptually the same as upgrading an 80 GB hard drive in a DVR to a 160 GB drive, and both of these are conceptually the same as what is being discussed here for the PC-like electronic device 100 in FIG. 1.

Continuing with the manufacturing process 400, in an optional step 422 a copy of the access logic 150 may be provided in the electronic device 100. This copy may be placed in the controller 110 or the logic unit 148 (if provided), say, in read only memory (ROM) in one of these, or this copy may be stored in the storage 114. This step is optional because having a copy of the access logic 150 “built in” in this manner during manufacturing is not a requirement. A copy of the access logic 150 can alternately be obtained later, say, by an end user of the electronic device 100, for instance, via use of any of the activation mechanisms 300.

Finally, in a step 424 the manufacturing process 400 ends. The electronic device 100 here is now complete and ready to be provided to a vendor or directly to an end user.

FIG. 5 is a flow chart of an upgrade process 500 that may be used in the inventive system 10 to enable access to an additional performance capacity in the electronic device 100 in FIG. 1 by using one of the activation mechanisms 300 in FIG. 3.

The upgrade process 500 begins in a step 510. Initialization and set-up typically occur here. For instance, the electronic device 100 reaches an end user by some means, e.g., by their purchasing it themselves, receiving it as a gift, or being provided with it by their employer. Typically, the electronic device 100 is also activated here in some manner by or for the end user. This is optional, however, and can vary and be very device specific based on the nature of the electronic device 100. For example, activation of a MP3 player is typically not needed. In contrast, activation of a personal computer (PC) is typically performed by a new user upon first powering up the device. And in further contrast, activation of a cellular telephone for a new user is typically performed by a service provider.

In a step 512, at some later time (emphasized with a dashed line in FIG. 5), the user is informed that they may upgrade the controller 110, the memory 112, the storage 114, or all of these in the electronic device 100. Typically this is done by a running an instance of the access logic 150 that uses the output interface 136 and the output device 134 of the electronic device 100 to deliver a message to the user. The access logic 150 can employ a variety of triggers for this, e.g., initial user activation, the passage of a set period of time, a set amount of usage, use of a substantial amount of already enabled capacity, etc. Alternately, the user may be aware about the option of upgrading and they themselves can trigger the access logic 150 to start an upgrade dialog.

In a step 514 the access logic 150 determines whether the user of the electronic device 100 has elected to upgrade a performance capacity in a performance-alterable component unit 102. Typically this is done by a running an instance of the access logic 150 and monitoring the input interface 132 and the input device 130 for a user reply. Alternately, if the electronic device 100 detects that an instance of the media-based mechanism 300a has been loaded into the media reader 138, an instance of the access logic 150 present there may be run, e.g., with an auto run dialog as is common in PCs.

If the user does not want to upgrade, in straightforward manner a step 516 follows where the upgrade process 500 ends. An optional part of step 516, however, can be a dialog informing the user that they can configure future occurrences of step 512. For instance, the user can be informed that they can set or change triggers for step 512, or even to turn off all triggers so that it will not automatically occur again.

Alternately, if the user does want to upgrade, a step 518 follows wherein the right to an upgrade is purchased. The term “purchase” apples very broadly here to mean that something of value is given in exchange for the right to an upgrade. For example, in many embodiments it is expected that the user or their employer can simply pay money for an upgrade, say, with a credit card. But users of some embodiments might instead “purchase” the right to an upgrade by registering for a service that provides a utility (e.g., telephone or Internet access), or a user may take an online survey or provide information about themselves such as an e-mail address.

After successful completion of step 518, a step 520 follows wherein one or more of the keys 310 are transferred to the electronic device 100. Optionally, a copy of the access logic 150 can also be transferred here. If the electronic device 100 does not already have a copy, one will be needed before the keys 310 can be used and this is a good time to procure it. Alternately, if the electronic device 100 has an older version of the access logic 150, this may be a suitable time to provide a newer version.

In a step 522, at some later time (emphasized with a dashed line in FIG. 5), one or more or all of the keys 310 that were received in step 520 are applied by the access logic 150. Typically the received keys 310 are applied as soon as they are received by the electronic device 100, but this is not a requirement. Also typical, all of the received keys 310 are usually applied together, but this also is not a requirement. The access logic 150 now enables the respective performance capacities in the respective component units 102 that are associated with the received keys 310 that are being applied.

In a step 524 a decision is made whether to stop the upgrade process 500. This decision can be made by the access logic 150 or by the user. If all of the available performance capacities have now been enabled, the access logic 150 can detect this and have step 516 automatically follow so the upgrade process 500 ends. Alternately, the user can be asked here if they want to stop (proceed to step 516) or return to step 512. For instance, the user may feel that this upgrade was so inexpensive and went so smoothly that they want to go ahead and upgrade further. Or the user may have procured more keys 310 than were applied in step 522, and here they can continue to apply some or all of those as well.

Of course, now that upgrading should be understood based on the above described exemplary upgrade process 500, downgrading should also be straightforward. Although upgrading, and leaving an electronic device with a higher performance capacity than before may be more common, there is no reason why downgrading, “trade-grading,” or even other performance capacity altering scenarios cannot be employed in the present inventive system 10. For instance, a user who upgraded the performance capacity of the image sensor in a cell phone may later decide that higher resolution images and video clips are not important to them, and voluntarily downgrade this performance capacity, presumably in response to some incentive like a lower monthly device rental fee from their service provider. Or our hypothetical cell phone user here may “trade-grade” by degrading the image sensor performance capacity in exchange for upgrading storage performance capacity, say, because they want the additional storage capacity for a large number of contacts, ringtones, etc.

Note here that some electronic devices might even now be provided by manufactures where trade-off-grading is necessary, say, where a battery or other power supply capacity is fixed and can be applied to a higher performance capacity in either a CPU or an image sensor but not both concurrently. Here a manufacture traditionally would not provide a mechanism for a user to change the device performance capacities, because the user might over-configure the device (that is, turn on the mutually exclusive options) and damage the device in the short term, reduce its usable life in the long term, become dissatisfied with it because it is unstable in operation, etc. But with the present inventive system 10 manufactures, vendors, those leasing equipment, etc. (“providers) can now control the performance capacities of electronic devices even after the devices are in the hands of end users.

With reference again briefly to FIG. 3, the stylized depiction of the electronic device 100 there includes just a few representative examples. Without limitation to the specific examples shown, which are merely those that conveniently fit in the available space in FIG. 3, these hint at the variety of electronic devices wherein the inventive system 10 may provide immediate and substantial benefit.

And now coming full-circle, back to how the inventive system 10 reduces electronic waste and our carbon footprint, we can now appreciate how rewards (as true incentives rather than penalties) are provided to reduce electronic waste and trash. Consumers now can have true incentives to keep cell phones for more than one year, PCs for more than two years, televisions for more than five years, and similarly keep other electronic devices longer. Technical and commercial rewards to consumers, vendors, and manufactures can now be leveraged to entice consumers to use their electronic devices longer. In sum, electronic waste and trash can now be reduced by use of the inventive system 10, and our carbon footprint can similarly be reduced by reducing manufacturing and its inherent usage of energy and materials.

While various embodiments of the electronic device 100, the activation mechanisms 300, manufacturing process 400, and upgrade process 500 have all been described above with the inventive system 10, it should be understood that they have been presented by way of example only, and that the breadth and scope of the invention should not be limited by any of the above described exemplary embodiments, but should instead be defined only in accordance with the following claims and their equivalents.

What is claimed is:

1. An electronic device, comprising a component unit having a total performance capacity including an enabled performance capacity and an additional performance capacity, wherein said additional performance capacity is prevented from being employed by the electronic device until enabled with an access logic run in the electronic device with a key associated with said additional performance capacity.

2. The electronic device of claim 1, further comprising a processor that controllably employs said enabled performance capacity and wherein said access logic is run in said processor in the electronic device.

3. The electronic device of device of claim 1, further comprising:
a first processor that controllably employs said enabled performance capacity;
a logic unit that includes a second processor; and wherein
said access logic is run in said second processor.

4. The electronic device of claim 1, further comprising an input system for the electronic device to receive a said key from a source external to the electronic device.

5. The electronic device of claim 4, wherein said input system includes a media reader to read a said key from a computer readable storage medium.

6. The electronic device of claim 4, wherein said input system includes an interface to receive a said key from said source external to the electronic device via a communications network.

7. A method for manufacturing an electronic device, comprising:
building the electronic device including a component unit that has an alterable performance capacity; and
configuring said component unit to have an enabled performance capacity and an additional performance capacity, wherein said additional performance capacity is prevented from being employed by the electronic device until enabled by an access logic running in the electronic device with a key associated with said additional performance capacity.

8. The method of claim 7, wherein said building further includes providing a processor that controllably employs said enabled performance capacity and said processor runs said access logic in the electronic device.

9. The method of claim 7, wherein:
said building further includes providing a first processor that controllably employs said enabled performance capacity;
said building further includes providing a logic unit that includes a second processor; and wherein
said access logic is run in said second processor.

10. The method of claim 7, wherein said building further includes providing an input system for the electronic device to receive said key from a source external to the electronic device.

11. The method of claim 10, wherein said input system includes a media reader to read said key from a computer readable storage medium.

12. The method of claim 10, wherein said input system includes an interface to receive said key from a said source external to the electronic device via a communications network.

13. A method for a user of an electronic device having a component unit that has an alterable performance capacity, wherein the alterable performance capacity includes an enabled performance capacity and an additional performance capacity that is prevented from being employed by the electronic device until enabled by an access logic being run in the electronic device with a key associated with the additional performance capacity, the method comprising:
running the access logic in the electronic device;
informing the user that an upgrade permitting access to the additional performance capacity is available;
determining if the user wishes said upgrade and, if so:
permitting the user to purchase said upgrade;
transferring the key associated with the additional performance capacity to the electronic device from a source external to the electronic device; and
applying the key associated with the additional performance capacity with the access logic to enable the additional performance capacity.

14. The method of claim 13, prior to said running, the method further comprising loading the access logic from a location external to the electronic device.

15. The method of claim 13, wherein the electronic device has an input system that includes a media reader, and wherein said source external to the electronic device is in a computer readable storage media placed in the media reader.

16. The method of claim 13, wherein the electronic device has an input system that includes an interface, and wherein said source external to the electronic device is on a communications network accessed with said interface.

17. The method of claims 13, wherein said running includes monitoring for a trigger and performing said informing only if said trigger specifically has or specifically has not occurred.

18. The method of claim 17, wherein said trigger is the passage of a period of time.

19. The method of claim 13, subsequent to said applying, the method further comprising monitoring for a trigger, and if said trigger specifically has or specifically has not occurred disabling the additional performance capacity that was enabled in said applying.

20. The method of claim 19, wherein said trigger is the passage of a period of time.
